(19) United States
(12) Patent Application Publication
(10) Pub. No.: US 2018/0331597 A1
(43) Pub. Date: Nov. 15, 2018

(54) ELECTRIC POWERHEAD

(71) Applicant: Briggs & Stratton Corporation, Wauwatosa, WI (US)

(72) Inventor: David Schulenberg, Sussex, WI (US)

(73) Assignee: Briggs & Stratton Corporation, Wauwatosa, WI (US)

(21) Appl. No.: 15/979,337

(22) Filed: May 14, 2018

Related U.S. Application Data
(60) Provisional application No. 62/506,421, filed on May 15, 2017.

(51) Int. Cl. H02K 7/14; H02K 7/108; H02K 11/00; H01M 2/10

(52) U.S. Cl. CPC H02K 7/145; H02K 7/108; F02B 63/02; H01M 2/1022; H02K 11/0094

(57) ABSTRACT

An electric powerhead includes a housing including a mounting plate including a shaft opening and a number of first openings arranged in a standard mini four-stroke engine mounting pattern, a base including a number of second openings arranged in a standard mini four-stroke engine support pattern, and an electric motor positioned within the housing, wherein the electric motor includes an output shaft that extends through the shaft opening of the mounting plate and wherein the output shaft is configured to rotate about an axis of rotation.

### CROSS-REFERENCE TO RELATED PATENT APPLICATIONS

This application claims the benefit of U.S. Provisional Application No. 62/506,421, filed May 15, 2017, which is incorporated herein by reference in its entirety.

### BACKGROUND

The present disclosure generally relates to prime movers for portable power equipment. More specifically, the present disclosure relates to an electric power head and energy storage device for driving and/or powering various components of a piece of portable power equipment.

### SUMMARY

One embodiment relates to an electric powerhead. The electric powerhead includes a housing including a mounting plate including a shaft opening and multiple first openings arranged in a standard mini four-stroke engine mounting pattern, a base including multiple second openings arranged in a standard mini four-stroke engine support pattern, and an electric motor positioned within the housing, wherein the electric motor includes an output shaft that extends through the shaft opening of the mounting plate and wherein the output shaft is configured to rotate about an axis of rotation.

Another embodiment relates to portable power equipment. The portable power equipment includes an electric powerhead including a housing including a mounting plate including a shaft opening and multiple first openings arranged in a standard horizontal shaft engine mounting pattern, a base including multiple second openings arranged in a standard horizontal shaft engine support pattern, a battery receptacle, an electric motor positioned within the housing, and a battery. The electric motor includes an output shaft that extends through the shaft opening of the mounting plate and the output shaft is configured to rotate about an axis of rotation. The battery is configured to be removably attached to the battery receptacle to provide electricity to the electric motor.

Alternative exemplary embodiments relate to other features and combinations of features as may be generally recited in the claims.

### BRIEF DESCRIPTION OF THE DRAWINGS

The disclosed implementations will become more fully understood from the following detailed description, taken in conjunction with the accompanying drawings, in which:

FIG. 1 is a front view schematic diagram of an electric powerhead, according to an embodiment;

FIG. 2 is a side view schematic diagram of the electric powerhead of FIG. 1, according to an embodiment;

FIG. 3 is a perspective view schematic diagram of the electric powerhead of FIG. 1 in use with portable power equipment, according to an embodiment;

FIG. 4 is a top view of a power take-off mounting plate for use with the electric powerhead of FIG. 1, according to an embodiment;

FIG. 5 is a bottom view of a base of the electric powerhead of FIG. 1, according to an embodiment;

FIG. 6 is a perspective view of a battery of the electric powerhead of FIG. 1, according to an embodiment;

FIG. 7 is a perspective view of an output shaft of the electric powerhead of FIG. 1, according to an embodiment;

FIG. 8 is a front view of the output shaft of FIG. 7, according to an embodiment; and

FIG. 9 is a perspective view of a portion of a string trimmer, according to an embodiment.

### DETAILED DESCRIPTION

Before turning to the figures, which illustrate multiple embodiments in detail, it should be understood that the application is not limited to the details or methodology set forth in the description or illustrated in the figures. It should also be understood that the terminology is for the purpose of description only and should not be regarded as limiting.

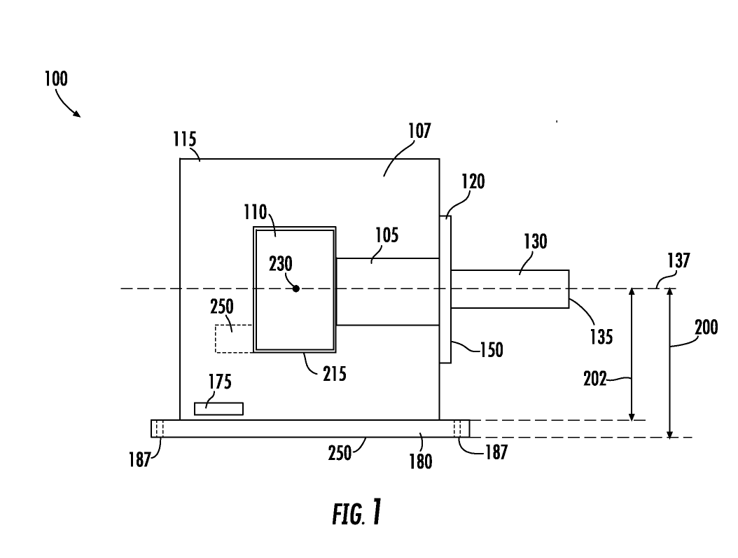

FIG. 1 illustrates an electric powerhead 100 according to one embodiment. The electric powerhead 100 includes an electric motor 105 and an energy storage device or battery 110 that powers the electric motor 105 and other electrical components. The electric powerhead 100 serves as a replacement for a small internal combustion engine of the type frequently used on a variety of equipment, including portable power equipment. Portable power equipment includes string trimmers, leaf blowers, chainsaws, pressure washers, hedge trimmers, tillers, edgers, vacuums, concrete vibrators, concrete screeds, earth/ice augers, paint sprayers, etc. Portable power equipment may, for example, use the electric powerhead 100 to drive an implement, such as a trimmer head or blade of a trimmer, a pump of a pressure washer, and/or a drivetrain of the portable power equipment.

The electric powerhead 100 also includes a housing 115 with a base 180 and a power take-off (PTO) mounting plate 120 for securing the electric powerhead 100 to a mounting location on a piece of equipment (e.g., to secure the electric powerhead 100 to a string trimmer). The housing 115 is sized so that the electric powerhead 100 has substantially the same volume as a comparable small internal combustion engine that provides a similar mechanical output (e.g., power and torque) so that the electric powerhead 100 can be used as a direct replacement for comparable small internal combustion engines. For example, comparable small internal combustion engines may include standard handheld (e.g., non-road) engines. Standard handheld engines may be rated as class III engines (e.g., total displacement of less than 20 cubic centimeters (cc)), class IV engines (e.g., total displacement between 20 cc and 50 cc), or as class V engines (e.g., total displacement over 50 cc) as defined by 40 C.F.R. § 1054.801 (e.g., EPA regulations).

The electric powerhead 100 provides a maximum output of approximately 1.0 horsepower (HP). In other embodiments, the electric powerhead 100 provides a maximum output of approximately 1.3 HP. In other embodiments, the electric powerhead 100 provides more or less maximum output. Standard small internal combustion engines having a similar output have standard dimensions including a standard height, a standard width, a standard depth, and a standard cross-sectional area or footprint (width times depth). For example, for comparable standard small internal combustion engines, the standard depth is approximately 7.6 inches (192 millimeters (mm)), the standard width is approximately 8.7 inches (221 mm), and the standard height is approximately 9.1 inches (230 mm), with a cross-sectional area of approximately 66.1 inches squared (4.24×10⁴ mm²) and a volume of approximately 601.7 cubic inches (9.76×10⁶ mm³). A distance, area, or volume is “substantially the same” as one of the standard distances, areas, or volumes of a comparable standard small engine when such a distance, area, or volume allows another component having such a distance, area, or volume to be readily used in place of the standard small engine. In some embodiments of the present invention, plus or minus 15% of the distance, area, or volume is the outer limit for a distance, area, or volume to be considered “substantially the same” as one of the standard distances, areas, or volumes.

As another example, for comparable standard small internal combustion engines, the standard depth is approximately 8.0 inches (204 mm), the standard width is approximately 9.2 inches (234 mm), and the standard height is approximately 9.4 inches (230 mm), with a cross-sectional area of approximately 73.6 inches squared (4.78×10⁴ mm²) and a volume of approximately 691.8 cubic inches (1.10×10⁷ mm³).

Still referring to FIG. 1, the electric motor 105 is positioned within the housing 115. The electric motor 105 may be directly supported by the housing 115 or supported by a cradle or other support structure located within the housing 115. In different embodiments, the electric motor 105 is provided with different power ratings (e.g. 1,500 watts, 2,500 watts, or 3,500 watts). In addition to the output shaft 130, the electric motor 105 includes a stator and a rotor. The rotor and the output shaft 130 rotate about the axis of rotation 137 when the electric motor 105 is activated. In some embodiments, a fan is coupled to the rotor and rotates to cause cooling air to pass over the electric motor 105 when activated.

The electric motor 105 is additionally configured to operate in a reverse direction of rotation. The reversibility of the electric motor 105 allows for reversibility of vehicular equipment, such as power wheel barrows, etc., and reversibility of other rotating handheld (and outdoor) power equipment, such as earth/ice augers, string trimmers, blowers, mowers, etc. For example, when using an earth auger, the auger may get stuck in a dug hole and reversibility of the motor allows the auger to reverse out of the hole, thereby freeing the auger from the earth. As another example, when using a mower, the mower deck may become clogged with grass and dirt trapped between the blade and the deck. Reversibility of the motor causes the mower blades to operate in a reverse direction, which may aid in clearing the clogged mower deck. As another example, when using a string trimmer, in certain orientations, the string trimmer may direct trimmings toward the operator. By selecting a reverse mode of the motor, the operator can direct clippings away from the operator during use. As a further example, when using a power wheel barrow, the powerhead may be used to power the wheels of the wheel barrow in a forward and reverse direction. Reversibility of the motor results in reversibility of the wheels of the wheel barrow, which may be necessary or desired during use (e.g., wheel barrow has been moved into a corner, toward a building, etc.).

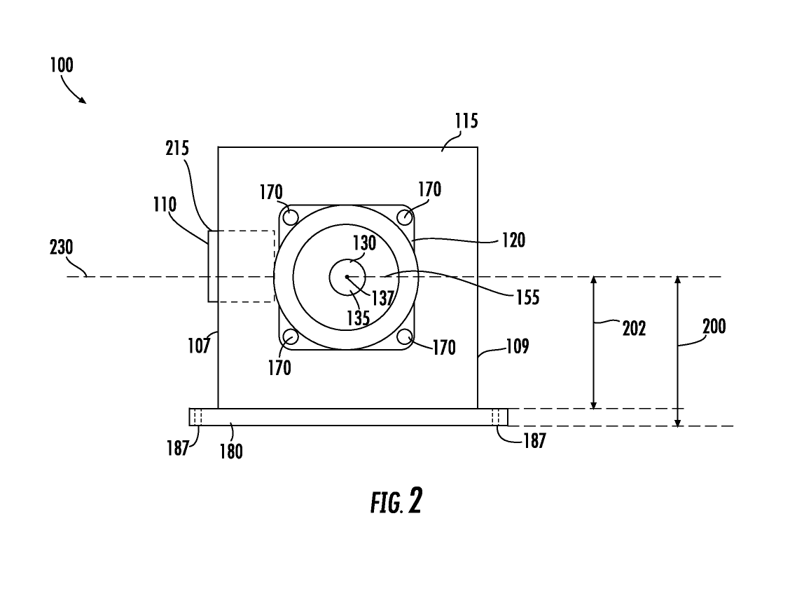

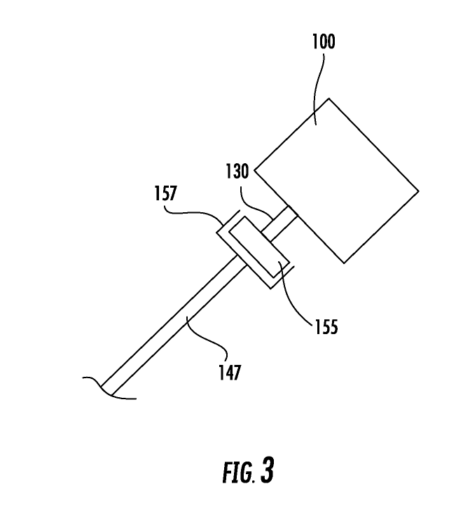

Referring to FIGS. 2-3, the electric powerhead 100 additionally includes a clutch 155. The clutch 155 is positioned around the axis of rotation 137 of the output shaft 130. In some embodiments, the center of the clutch 155 is positioned at a height 200 away from the bottom of base 180. In some embodiments, the height 200 is 3.78 inches (96 mm). In some embodiments, the center of the clutch 155 is positioned at a height 202 away from the bottom of housing 115. In some embodiments, the height 202 is 3.31 inches (84 mm). In some embodiments, the height 202 is 3.19 inches (81 mm). The dimensions and placement of the clutch 155 allow original equipment manufacturers (OEMs) to use the electric powerhead 100 as a direct replacement for standard small internal combustion engines (e.g., mini four-stroke engines). The inclusion of a clutch 155 permits the direct replacement of a standard small internal combustion engine with the electric powerhead 100 without changing (or effecting very little change to) the PTO mounting assembly on the power equipment. For example, when completing a direct replacement (e.g., drop-in) of a standard small engine for the electric powerhead 100, OEMs do not need to change the implement of the power equipment (e.g., do not need to include a receptacle for accepting the PTO). Instead, as shown in FIG. 3, the clutch 155 mates with an existing clutch drum 157 on the equipment. The clutch drum 157 is in turn coupled to a drive shaft 147 of the equipment such that power transfer from the electric powerhead 100 to the implement (e.g., via clutch 155 and clutch drum 157) occurs. The clutch 155 allows the electric powerhead 100 to run at an idle speed without engaging the clutch drum 157 and causing an implement on the equipment to function. The clutch 155 is configured to engage the clutch drum 157 when the output shaft 130 speed is increased such that the speed of the electric motor 105 can be increased from no speed to full speed with ease.

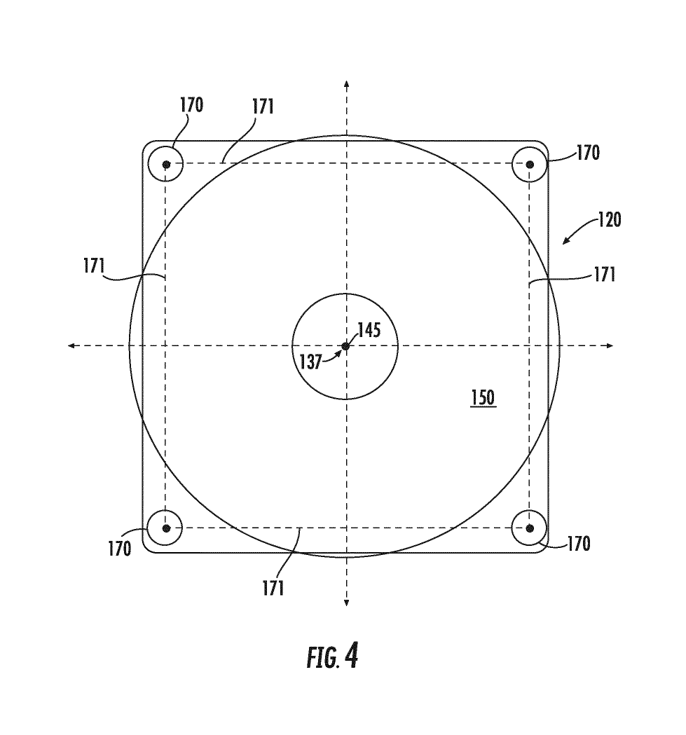

Referring to FIG. 4, the PTO mounting plate 120 includes a set of openings 170 arranged in a standard small (e.g., mini four-stroke, handheld, non-road) engine mounting pattern (e.g., an SAE or other industry standard for mounting handheld internal combustion engines). Engine mounting patterns are standardized so that engines produced by different engine manufactures can be mounted to equipment produced by different OEMs without having to customize the mounting arrangement between the engine and the equipment. This allows an OEM to offer the same equipment with different engines from different manufacturers to meet the OEM's engine needs or the customer's engine needs. Bolts or other fasteners are inserted through the openings 170 to attach the PTO mounting plate 120 at a desired mounting location. In other embodiments, the PTO mounting plate 120 includes two or more sets of openings with each set arranged in a standard engine mounting pattern. In the illustrated embodiment, the set of openings 170 has four openings 170. The four openings 170 are arranged in a square centered at the origin 145 and spaced apart from each other by a distance 171. In some embodiments, the openings 170 have a diameter of approximately 0.25 inches. In other embodiments, the openings 170 have a diameter of approximately 0.2362 inches (6 mm). In some embodiments, the distance 171 is approximately 2.28 inches (58 mm). In other embodiments, the distance 171 is approximately 2.78 inches (70.7 mm).

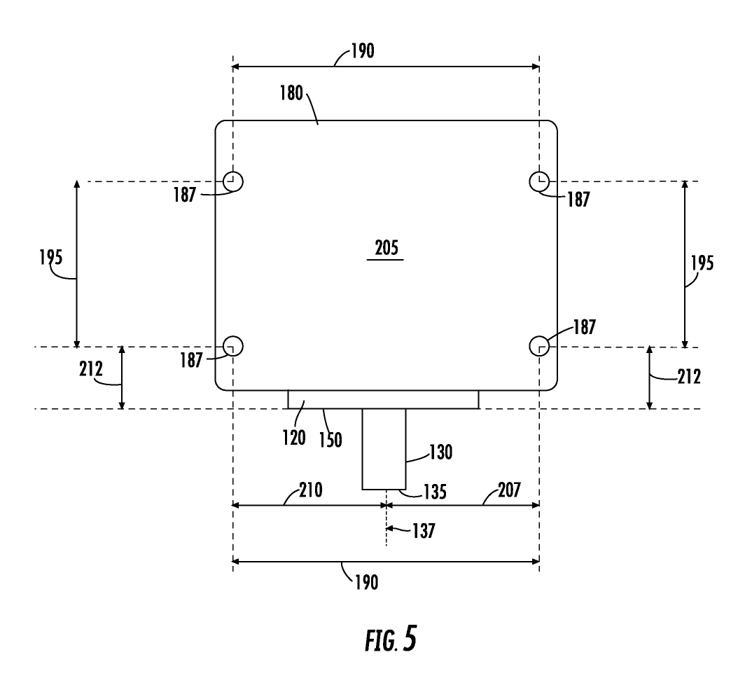

As shown in FIG. 5, the base 180 includes a set of openings 187 arranged in a standard small (e.g., mini four-stroke, handheld, non-road) horizontal engine support pattern. Bolts or other fasteners are inserted through the openings 187 to attach the base 180 at a desired mounting location. Like the engine mounting patterns discussed above, horizontal engine support patterns are standardized. In the illustrated embodiment, the set of openings 187 includes four openings 187 arranged in a rectangle having a first distance or width 190 between the center points of two openings 187 and a second distance or depth 195 between the center points of two openings 187. In some embodiments, the width 190 is 1.97 inches (50 mm). In some embodiments, some or all of the openings 187 have a diameter of 0.25 inches. In other embodiments, some or all of the openings have a diameter of 0.2362 inches (6 mm). In some embodiments, the front openings 187 (i.e., those closest to the outer surface 150 of the mounting plate 120) are elongated slots. In some embodiments, the height 200 (shown in FIGS. 1-2) is 3.78 inches (96 mm). In some embodiments, the height 202 (shown in FIGS. 1-2) is 3.31 inches (84 mm). In some embodiments, the height 202 is 3.19 inches (81 mm). The center points of the front openings 187 in the base 180 (i.e., those closest to the outer surface 150 of the mounting plate 120) are spaced a distance 212 from the outer surface 150 of the mounting plate 120. The center points of the left and right front openings 187 in the base are spaced a distance 210 and a distance 207 from the axis of rotation 137 of the output shaft 130, respectively. Like the engine mounting patterns and support patterns, discussed above, the height of the axis of rotation of the output shaft of a horizontal shaft engine above a mounting surface, the location of the axis of rotation relative to the supporting pattern, and the location of the supporting pattern relative to the mounting plate are standardized.

In some embodiments, the PTO mounting plate 120 and/or base 180 include plastic molded over a metallic insert. The PTO mounting plate 120 and base 180 are made from molded plastic and the insert is made from an aluminum material. In other embodiments, the PTO mounting plate 120, base 180, and insert are made from other materials. The insert includes a ring-shaped portion and a set of bosses or protrusions extending outward from the outer surface of the ring-shaped portion. In other embodiments, the insert includes a rectangular-shaped portion with a set of bosses or protrusions extending therefrom. The insert includes a set of openings including four openings that align concentrically with the set of openings 170, 187 on the PTO mounting plate 120 and base 180, respectively. Each opening on the insert extends through the center of a protrusion. The openings of the insert are smaller in diameter than the openings 170, 187 of the PTO mounting plate 120 and base 180 such that the protrusions extend through and are approximately flush with the outer surfaces of the PTO mounting plate 120 and base 180. Accordingly, bolts or other fasteners that are used to mount the engine powerhead 100 to a piece of portable power equipment extend through the openings in the insert and PTO mounting plate 120 and/or base 180 and engage with (e.g., clamp against) the surfaces of the insert protrusions instead of engaging with the PTO mounting plate 120 and/or base 180. As such, when mounting the engine powerhead 100 to a piece of equipment, fasteners are engaged with the metallic material of the insert and not against the plastic material of the PTO mounting plate 120 and/or base 180. By fastening a metallic fastener against the metallic material of the insert, loosening of fasteners over time due to thermal changes and deformation of the plastic material is avoided.

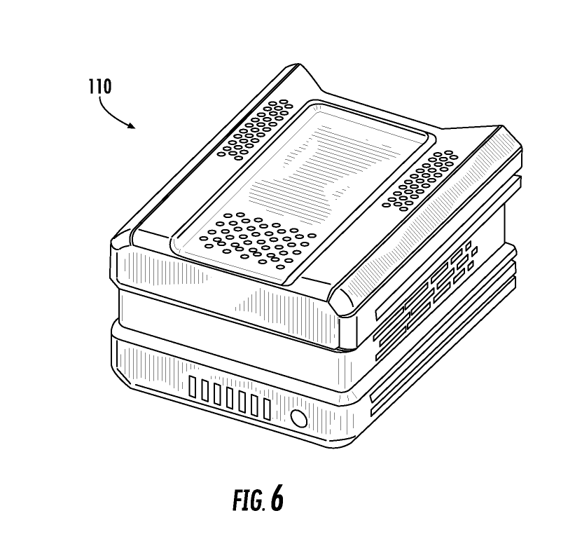

Referring back to FIG. 1, the housing 115 includes a battery receptacle 215 configured to receive a removable battery 110 (shown in FIG. 6). The removable battery 110 is able to be attached to and removed from the battery receptacle 215 without the use of tools. In other embodiments, the battery 110 may be attached to the housing 115 in a fixed manner that would require the use of tools to remove the battery 110 from the housing. The battery receptacle 215 and the battery 110 include contacts that are configured to engage or connect with each other to complete an electrical circuit when the battery 110 is attached to the battery receptacle 215. This allows the battery 110 to provide electricity to the electric motor 105 and other electrical components as will be explained in more detail below. The battery 110 includes multiple electrochemical battery cells. According to one embodiment, each cell is a cylindrical lithium ion (Li-ion) cell that extends along a longitudinal cell axis. In other embodiments, the cells may be differently shaped (e.g., prismatic cells) or may have different battery chemistries (e.g., nickel-cadmium, lead-acid, nickel metal hydride, nickel-zinc, etc.). The battery 110 may be provided in different configurations providing different energy capacities and voltage ratings. For example, in some embodiments the battery 110 provides between one hundred fifty (150) and five hundred (500) watt hours of energy at a voltage rating of 82 volts. In other embodiments, different energy capacities and voltage ratings are provided. In some embodiments, multiple batteries 110 and battery receptacles 215 are provided to increase the amount of electrical energy available for use by the electric powerhead 100.

The battery receptacle 215 is positioned in the housing 115 so that a straight axis of insertion 230 along which the battery 110 is inserted into the battery receptacle 215 is positioned at an angle relative to the axis of rotation 137 of the output shaft 130. For example, as shown in FIG. 1, the axis of insertion 230 is going into/coming out of the page such that the axis of insertion 230 is perpendicular to the axis of rotation 137. The battery receptacle 215 includes a stop surface 205 that is configured to contact a face or other surface of the battery 110 when the battery 110 is inserted into the battery receptacle 215 to limit the insertion of the battery 110 into the battery receptacle 215. In some embodiments, the axis of insertion 230 is orthogonal to the stop surface 205 of the battery receptacle 215. In some embodiments, when the battery 110 is attached to the battery receptacle 215, the longitudinal axes of the battery cells of the battery 110 are parallel to the axis of insertion 230.

As illustrated in FIG. 1, the battery 110 and battery receptacle 215 are positioned proximate the front 107 of the housing 115. In other embodiments, the battery 110 and battery receptacle 215 are positioned proximate the rear 109 (FIG. 2) of the housing 115. As such, the battery 110 is positioned in substantially the same location as a fuel fill, recoil cover, or air filter service location on a comparable small internal combustion engine (e.g., mini four-stroke engine). In each of the embodiments described, the battery 110 is readily accessible to a user on the top or rear portions 107, 109 of the housing 115 so that the user can insert and remove the battery 110 without removing the electric powerhead 100 from a mounted position on a piece of portable power equipment (e.g., the string trimmer shown in FIG. 9). By positioning the battery 110 in locations common for positioning either a fuel fill (fuel tank), a recoil starter, or an air filter serving location, no customizing is needed on equipment from various OEMs because the OEM shrouding on various equipment includes existing access to those location points. This allows the electric powerhead 100 to be used as a direct replacement for a small internal combustion engine (e.g., mini four-stroke engine) used on various equipment produced by different OEMs without the need for retooling.

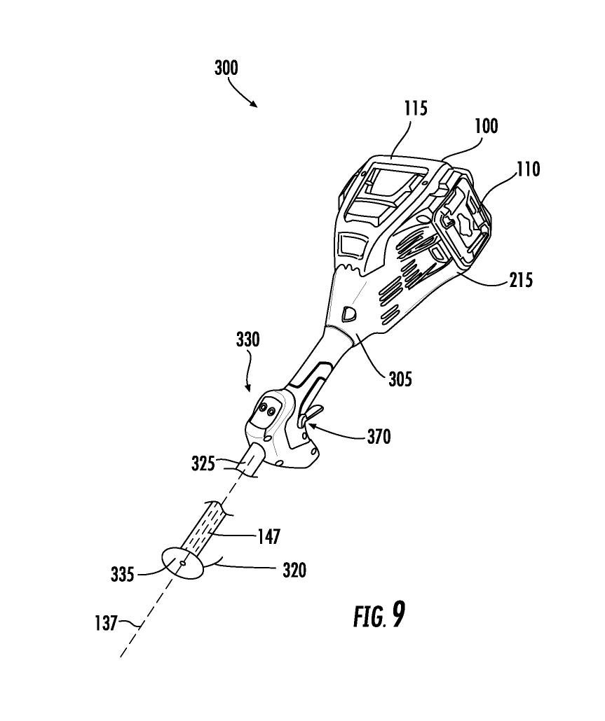

In some embodiments, the battery 110 and the battery receptacle 215 include mechanical aligning features to ensure proper alignment between the battery 110 and the battery receptacle 215 and/or to guide the battery 110 into the battery receptacle 215. For example, the battery 110 includes a protrusion and the battery receptacle 215 includes a corresponding slot to receive the protrusion. In some embodiments, the housing 115 includes a battery cover to secure the battery 110 to the battery receptacle 215. In such applications as the string trimmer shown in FIG. 8, the housing 115 must include a protective battery cover for purposes of compliance with regulations (e.g., ANSI/OPEI B175.3 standards). The battery 110 may be removed and attached to a charging station to charge the battery 110. The charging station connects to a source of electricity (e.g., the power grid, a generator, etc.) and may include a transformer. Alternatively or additionally, the battery 110 or the housing 115 includes an outlet or port to connect to a charging device. The charging device includes a plug and a cord to connect the outlet to a source of electricity (e.g., the power grid, a generator, etc.) and may include a transformer.

In some embodiments, an intake air filter is provided upstream of a motor intake air vent 175 to limit the intake of debris into the housing 115 with the intake of air through the vent 175. In some embodiments, the intake air filter includes a housing and a filter cartridge removably inserted into or attached to the housing 115. The filter cartridge includes filter media for filtering the air flow through the intake air filter. In some embodiments, the housing and/or the filter cartridge are arranged to provide cyclonic filters before filtering by the filter media by inducing a cyclonic airflow to remove debris from the airflow. The filter media is made of a washable material, such as a nylon or plastic mesh material. The filter media may have an Ingress Protection Rating of IP-67 (indicating waterproof and dust resistance). In other embodiments, the filter media is made of paper. In some embodiments, the electric motor 105 drives the fan used to draw air into a motor intake air vent 175 in an opposite direction to clear debris from the motor intake air vent 175 and/or the intake air filter.

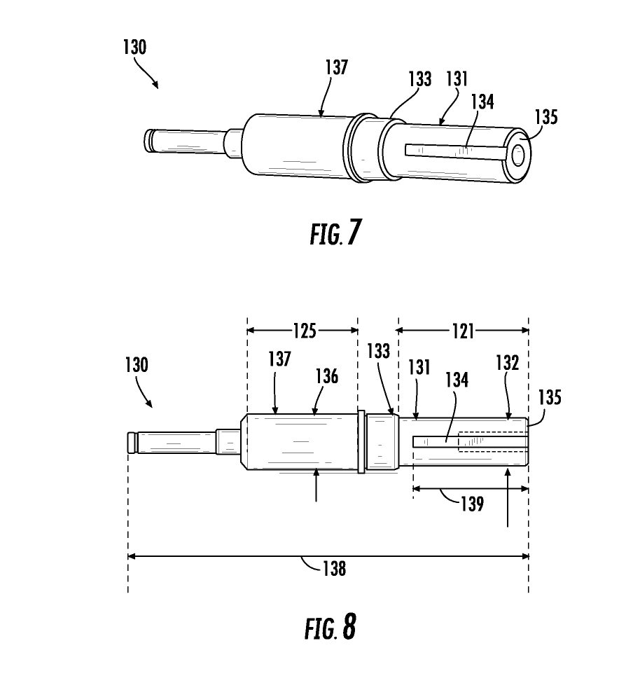

As shown in FIGS. 7-8, the output shaft 130 includes a first diameter 132 extending along a first portion 131 for a first length 121, a second diameter 136 extending along a second portion 137 for a second length 125, and an overall length 138. The first diameter 132 is smaller than the second diameter 136, with a step 133 positioned between the first and second diameters 132, 136. In other embodiments, the first diameter 132 is larger than the second diameter 136. In other embodiments, the first diameter 132 and second diameter 136 are the same. A keyway 134 extends from the end 135 along the first portion 131 for a length 139. The output shaft 130 is dimensionally similar to existing engine output shafts such that the output shaft 130 can be used across a wide variety of applications already using the existing engines. With such dimensions, OEMs can use the output shaft 130 of the electric powerhead 100 without need for custom fitting or accessories to couple the output shaft 130 to existing equipment.

The electric powerhead 100 also includes a controller or processing circuit 250 for controlling operation of electrical components of the powerhead 100. In some embodiments, the controller 250 also controls operation of and/or communicates with electrical components coupled to the electric powerhead 100 (e.g., electrically coupled by wires or wirelessly coupled). The controller 250 can include a processor and memory device. The processor can be implemented as a general purpose processor, an application specific integrated circuit (ASIC), one or more field programmable gate arrays (FPGAs), a group of processing components, or other suitable electronic processing components. The memory device (e.g., memory, memory unit, storage device, etc.) is one or more devices (e.g., RAM, ROM, Flash memory, hard disk storage, etc.) for storing data and/or computer code for completing or facilitating the various processes, layers and modules described in the present application. The memory device may be or include volatile memory or non-volatile memory. The memory device may include database components, object code components, script components, or any other type of information structure for supporting the various activities and information structures described in the present application. According to an exemplary embodiment, the memory device is communicably connected to the processor via a processing circuit and includes computer code for executing (e.g., by processing circuit and/or processor) one or more processes described herein. The controller 250 may be positioned in and/or attached to the housing 115.

In some embodiments, an accessory interface is electrically coupled to the controller 250 to provide data communications (e.g., transmission and receipt of input and output signals or other data streams) with external electrical components via a communication port. In some embodiments, the accessory interface includes a wireless transceiver to provide for wireless communication with an external electrical component. In some embodiments, a communication port can be used to allow an OEM or service provider to send controller programming updates (e.g., firmware updates, software updates) to the controller 250. In some embodiments, the controller 250 is programmed to detect the type of equipment the electric powerhead 100 is being used with. For example, the controller 250 can be programmed to detect equipment-specific external electrical components (e.g., plug-and-play components) and adjust operating characteristics of the electric powerhead 100 according to instructions specific to that equipment. For example, resistors in a wiring harness create a voltage indicating the type of equipment (e.g., looked up via a look-up table). As another example, NFC, RFID, Bluetooth, or a signal embedded in a wired connection (e.g., connected to a controller on the equipment) can be used to detect equipment-specific external electrical components.

FIG. 9 illustrates a string trimmer 300 according to an exemplary embodiment. The string trimmer 300 includes an electric powerhead 100 attached to a mounting location 305. The electric powerhead 100 includes a battery receptacle 215 and removable battery 110, thereby providing electrical energy for use by the electric powerhead 100 and any external electrical components connected to the electric powerhead 100. A handle 325 extends from the body of the string trimmer 300 and includes a user interface 330 for the user to grasp to direct the travel of the string trimmer 300. User hand controls 370 are provided at the user interface 330 to allow the user to provide operating commands (e.g., to activate or stop rotation of the string trimmer). Types of user hand controls include one or more switches, buttons, sliders, levers, dials, touch screens, positions sensors, torque sensors, force sensors, and other user input devices. The string trimmer 300 includes a trimmer head 335 driven by drive shaft 147 and positioned within the handle 325. The trimmer head 335 rotates about the axis of rotation 137 of the output shaft 130. The trimmer head 335 includes a string 320 attached thereto for trimming purposes. A user can activate the user hand controls 370 to start and stop rotation of the trimmer head 335 and string 320.

The construction and arrangement of the apparatus, systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, some elements shown as integrally formed may be constructed from multiple parts or elements, the position of elements may be reversed or otherwise varied and the nature or number of discrete elements or positions may be altered or varied. Accordingly, all such modifications are intended to be included within the scope of the present disclosure. The order or sequence of any process or method steps may be varied or re-sequenced according to alternative embodiments. Other substitutions, modifications, changes, and omissions may be made in the design, operating conditions and arrangement of the exemplary embodiments without departing from the scope of the present disclosure.

What is claimed is:

1. An electric powerhead, comprising:
a housing comprising:
a mounting plate including a shaft opening and a plurality of first openings arranged in a standard mini four-stroke engine mounting pattern;
a base comprising a plurality of second openings arranged in a standard mini four-stroke engine support pattern; and
an electric motor positioned within the housing, wherein the electric motor includes an output shaft that extends through the shaft opening of the mounting plate and wherein the output shaft is configured to rotate about an axis of rotation.

2. The electric powerhead of claim 1, further comprising a clutch configured to allow drop-in replacement of the electric powerhead in place of a standard mini four-stroke engine without changing a mounting assembly of the output shaft;
wherein the clutch is configured to engage with an existing clutch drum on a piece of equipment.

3. The electric powerhead of claim 1, wherein the plurality of first openings comprises four openings.

4. The electric powerhead of claim 1, wherein the plurality of second openings comprises four openings.

5. The electric powerhead of claim 1, wherein a bottom surface of the base is spaced apart from the axis of rotation of the output shaft by a vertical distance equal to a standard mini four-stroke engine spacing.

6. The electric powerhead of claim 5, wherein the vertical distance is between 3.7 and 3.8 inches.

7. The electric powerhead of claim 1, wherein a diameter of the output shaft is equal to a standard mini four-stroke engine output shaft diameter.

8. The electric powerhead of claim 1, wherein a length of the output shaft is equal to a standard small engine output shaft length.

9. The electric powerhead of claim 1, further comprising a battery configured to provide electricity to the electric motor.

10. The electric powerhead of claim 9, further comprising a battery receptacle positioned on the housing, wherein the battery is configured to be removably attached to the battery receptacle without the use of tools.

11. The electric powerhead of claim 10, wherein the battery receptacle is positioned so that a straight axis of insertion along which the battery is inserted into the battery receptacle is position at an orthogonal angle relative to the axis of rotation of the output shaft.

12. Portable power equipment, comprising:
an electric powerhead comprising:
a housing comprising:
a mounting plate including a shaft opening and a plurality of first openings arranged in a standard horizontal shaft engine mounting pattern;
a base comprising a plurality of second openings arranged in a standard horizontal shaft engine support pattern;
a battery receptacle;
an electric motor positioned within the housing, wherein the electric motor includes an output shaft that extends through the shaft opening of the mounting plate and wherein the output shaft is configured to rotate about an axis of rotation; and
a battery configured to be removably attached to the battery receptacle to provide electricity to the electric motor.

13. The portable power equipment of claim 12, further comprising a clutch configured to allow drop-in replacement of the electric powerhead in place of a standard mini four-stroke engine without changing a mounting assembly of the output shaft.

14. The portable power equipment of claim 12, wherein the plurality of first openings comprises four openings.

15. The portable power equipment of claim 12, wherein the plurality of second openings comprises four openings.

16. The portable power equipment of claim 12, wherein a bottom surface of the base is spaced apart from the axis of rotation of the output shaft by a vertical distance equal to a standard mini four-stroke engine spacing.

17. The portable power equipment of claim 16, wherein the vertical distance is between 3.7 and 3.8 inches.

18. The portable power equipment of claim 12, wherein a diameter of the output shaft is equal to a standard mini four-stroke engine output shaft diameter.

19. The portable power equipment of claim 12, wherein a length of the output shaft is equal to a standard mini four-stroke engine output shaft length.

20. The portable power equipment of claim 12, wherein the battery receptacle is positioned proximate a recoil cover location of a standard mini four-stroke engine recoil cover location.
